(19) United States
(12) Patent Application Publication
(10) Pub. No.: US 2005/0254500 A1
(43) Pub. Date: Nov. 17, 2005

(54) Inverse multiplexing for ATM

(75) Inventors: Markus Hauenstein, Dusseldorf (DE); Stephan Grunloh, Osnabruck (DE)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/929,799

(22) Filed: Aug. 31, 2004

Related U.S. Application Data
(60) Provisional application No. 60/570,502, filed on May 13, 2004.

(51) Int. Cl. H04L 12/56

(52) U.S. Cl. 370/395.1

(57) ABSTRACT

A system for distributing cells of an ATM cell stream across IMA links via interfaces or recombining ATM cells received from IMA links via interfaces into an ATM cell stream. In this system, IMA is no longer restricted to one physical interface module, and the IMA standard can be applied as it is specified. In other words, up to 32 physical interfaces can be used. The system includes a first module including N interfaces, the interfaces including L virtual interfaces (L≦N), at least one additional physical interface module including physical interfaces, and a network architecture for connecting the physical interfaces of the additional physical interface modules to the virtual interfaces of the first module. Thus, IMA can encompass several physical interface modules, and practical restrictions in the number of physical interfaces can be overcome.

### FIELD OF THE INVENTION

In general, the present invention relates to IMA (Inverse Multiplexing for ATM (Asynchronous Transfer Mode)). In particular, the invention relates to a system and a method of distributing cells of an ATM cell stream across IMA links via interfaces or recombining ATM cells received from IMA links via interfaces into an ATM cell stream.

### BACKGROUND OF THE INVENTION

FIG. 7 shows an IMA functionality according to the prior art. IMA splits a source ATM cell stream in several cell substreams for transmission. The cell substreams are then combined at a destination to reconstruct the original stream. This enables transmission of high bandwidth streams over low bit rate links by bundling several links. The cell stream division procedure is called inverse multiplexing.

The cells are transmitted cell by cell on the different links on a cyclic (round-robin) basis. Special IMA Control Protocol cells (ICP) are introduced after some payload cells (e.g. 127). These payload cells and the ICP cell form the so-called IMA frame. Each ICP cell contains a link identifier, an IMA frame sequence number and several fields for synchronization and monitoring purposes.

The IMA functions form an IMA sublayer which belongs to the Transmission Convergence (TC) Sublayer of the Physical Layer of the ATM layer reference model. The TC sublayer is then further subdivided in an upper IMA specific TC sublayer and a lower Interface Specific TC sublayer. The IMA specific TC sublayer is responsible for cell stream splitting and reconstruction, ICP cell insertion and removal, cell rate decoupling, IMA frame synchronization, stuffing and discarding of cells with erroneous HEC (Header Error Correction).

According to the IMA standard AF-PHY-0086.00, an IMA group can consist of up to 32 physical interfaces. However, state-of-the-art ATM nodes do only support a small number of interfaces in one IMA group (e.g. eight). The reason behind is an implementation restriction: All physical interfaces in one IMA group must belong to the same physical interface module, and a typical physical interface module does only have fewer interfaces (namely e.g. eight).

### SUMMARY OF THE INVENTION

It is an object of the invention to overcome the implementation restriction of the prior art and to increase the number of interfaces which can be handled in an IMA group.

According to an aspect of the invention, a system for distributing cells of an ATM cell stream across IMA links via interfaces or recombining ATM cells received from IMA links via interfaces into an ATM cell stream is provided, the system comprising a module implementing and operating an IMA sublayer, the module comprising N interfaces, the interfaces comprising L virtual interfaces wherein L≦N, and at least one physical interface module comprising physical interfaces connecting to the virtual interfaces of the module implementing and operating the IMA sublayer.

According to another aspect of the invention, a module implementing and operating an IMA group distributing cells of an ATM cell stream across IMA links via interfaces or recombining ATM cells received from IMA links via interfaces into an ATM cell stream is provided, the module comprising N interfaces, the interfaces comprising L virtual interfaces connected to physical interfaces of at least one physical interface module, wherein L≦N.

Furthermore, a method of distributing cells of an ATM cell stream across IMA links via interfaces or recombining ATM cells received from IMA links via interfaces into an ATM cell stream is provided, the method comprising a step of transceiving ATM cells via L virtual interfaces of a module implementing and operating an IMA sublayer, the module implementing and operating the IMA sublayer comprising N interfaces, wherein L≦N, and wherein at least one of the L virtual interfaces of the module implementing and operating the IMA sublayer is connected with a physical interface of at least one physical interface module.

According to a further aspect of the invention, a physical interface module of an IMA group distributing cells of an ATM cell stream across IMA links via interfaces or recombining ATM cells received from the IMA links via interfaces into the ATM cell stream is provided, the physical interface module comprising physical interfaces connected to virtual interfaces of at least one other module implementing and operating an IMA group.

Furthermore, a method of distributing cells of an ATM cell stream across IMA links via interfaces or recombining ATM cells received from IMA links via interfaces into an ATM cell stream is provided, the method comprising a step of transceiving ATM cells via physical interfaces of at least one physical interface module, wherein at least one physical interface of the at least one physical interface module is connected with a virtual interface of a module implementing and operating an IMA sublayer.

According to a still further aspect of the invention, a network architecture for transferring ATM cells belonging to ATM cell substreams resulting from IMA processing is provided, the network architecture comprising transferring means for transferring ATM cells, and connecting means for connecting virtual interfaces of a module implementing and operating an IMA sublayer and physical interfaces of at least one physical interface module.

Furthermore, a method of distributing cells of an ATM cell stream across IMA links via interfaces or recombining ATM cells received from the IMA links, via the interfaces into an ATM cell stream is provided, the method comprising a step of connecting physical interfaces of at least one physical interface module to virtual interfaces of another module.

The invention may also be embodied as computer program.

According to the invention, IMA groups are no longer restricted to one physical interface module. IMA can encompass several physical interface modules. The invention enables to apply the IMA standard as it is specified, i.e. to use up to 32 physical interfaces.

Therefore, practical restrictions in the number of physical interfaces for one IMA group can be overcome.

### BRIEF DESCRIPTION OF THE DRAWINGS

FIG. 1 shows an arrangement of a multi-module IMA illustrating a transmitter side of an IMA virtual link according to a first embodiment of the invention.

FIG. 2 shows an arrangement of a multi-module IMA illustrating a receiver side of an IMA virtual link according to the first embodiment of the invention.

FIG. 3 shows an arrangement of a multi-module IMA illustrating a transmitter side of an IMA virtual link according to a second embodiment of the invention.

FIG. 4 shows an arrangement of a multi-module IMA illustrating a receiver side of an IMA virtual link according to the second embodiment of the invention.

FIG. 5 shows an example of a transport node applying multi-module IMA according to the invention.

FIG. 6 shows an example of a transport node without multi-module IMA.

FIG. 7 shows an arrangement of IMA according to the prior art.

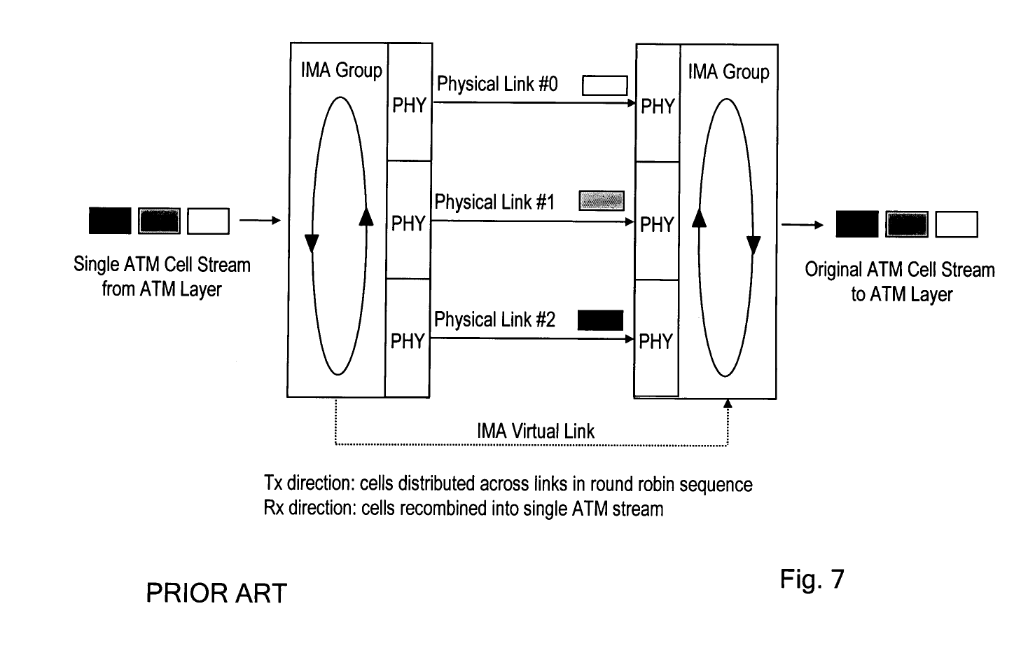

### DESCRIPTION OF THE PREFERRED EMBODIMENTS

The invention proposes to distribute IMA links of an IMA group among physical interface modules. In other words, physical interfaces from different physical interface modules are put into one IMA group. For this purpose, in addition to real physical interfaces (PHYs), also virtual interfaces (virtual PHYs) are used. Virtual interfaces connect to physical interfaces on other physical interface modules, and ATM cells received by the physical interfaces are forwarded to the virtual interfaces and vice versa via a node-internal network architecture, which is e.g. Ethernet. Virtual interfaces have the same interface to an IMA sublayer as physical interfaces so that there is no difference for the IMA sublayer and no changes are required for the IMA sublayer.

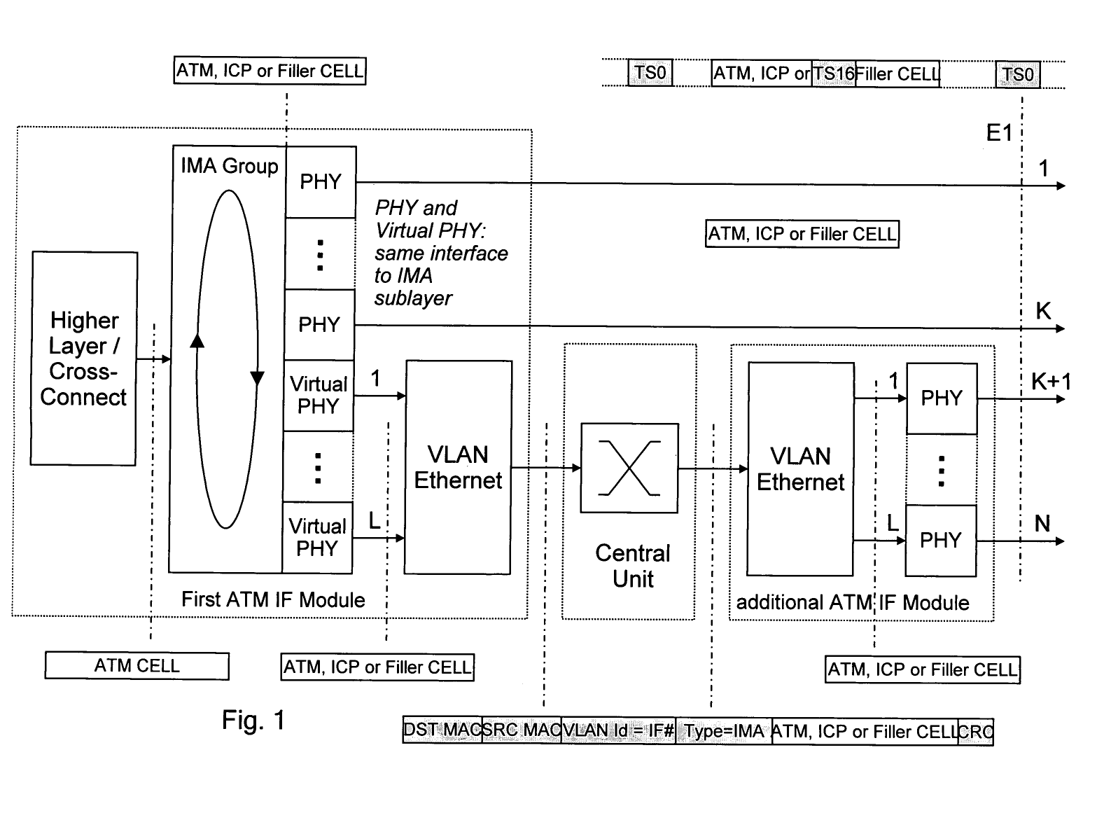

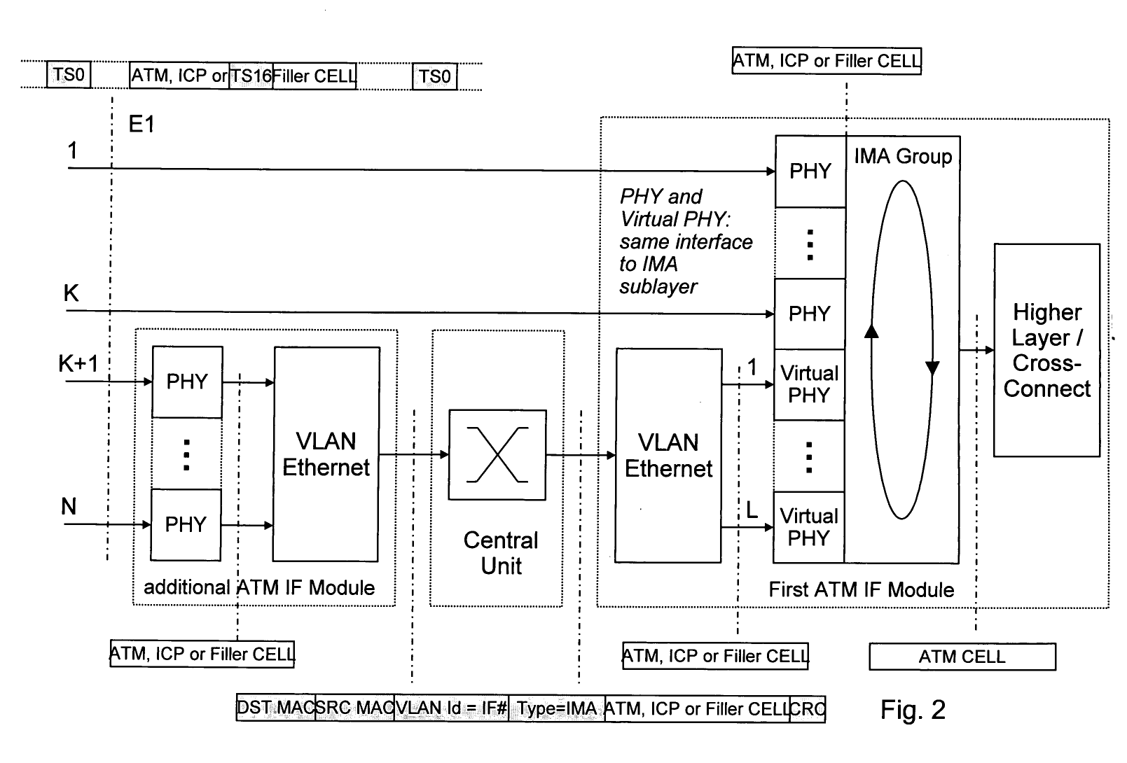

FIG. 1 shows a transmitter side of the multi-module IMA virtual link according to a first embodiment of the invention, and FIG. 2 shows a receiver side of a multi-module IMA virtual link according to the first embodiment of the invention.

According to FIGS. 1 and 2, a source ATM cell stream is split into several cell substreams for transmission over IMA links 1 to N of an IMA virtual link by an IMA group at the transmitter side of the IMA virtual link (FIG. 1), or ATM cell substreams received from IMA links 1 to N are combined by an IMA group at the receiver side of an IMA virtual link to reconstruct an original ATM cell stream (FIG. 2). A first ATM physical interface module in the multi-module IMA of FIGS. 1 and 2 comprises N interfaces, the interfaces comprising K physical interfaces (PHY) and L virtual interfaces (virtual PHYs) (K+L=N). Moreover, the multi-module IMA comprises at least one additional physical interface module with physical interfaces (PHYs). A network architecture connects the physical interfaces of the additional physical interface module(s) to the virtual interfaces of the first physical interface module. The first physical interface module implements and operates an IMA sublayer, whereas the additional physical interface module(s) do not implement or do not operate an IMA sublayer.

The network architecture, e.g. a transport node-internal network architecture, connecting the virtual interfaces of the first physical interface modules to the physical interfaces of the additional physical interface modules may e.g. be realized by VLAN Ethernet with an Ethernet switch element located on a central module and Ethernet point-to-point links connecting the physical interface modules to the Ethernet switch element. The switch element transfers ATM cells belonging to ATM cell substreams resulting from IMA processing between the modules.

The first physical interface module may also comprise K physical interfaces (K=N−L) which are not switched to additional physical interface modules but are directly used for the IMA virtual link as shown in FIGS. 1 and 2.

In a practical implementation, all physical interface modules might be identical. I.e. all interface modules might implement an IMA sublayer. But only the first interface module will then actually operate its IMA sublayer. The IMA sublayer will then be deactivated on the additional interface modules.

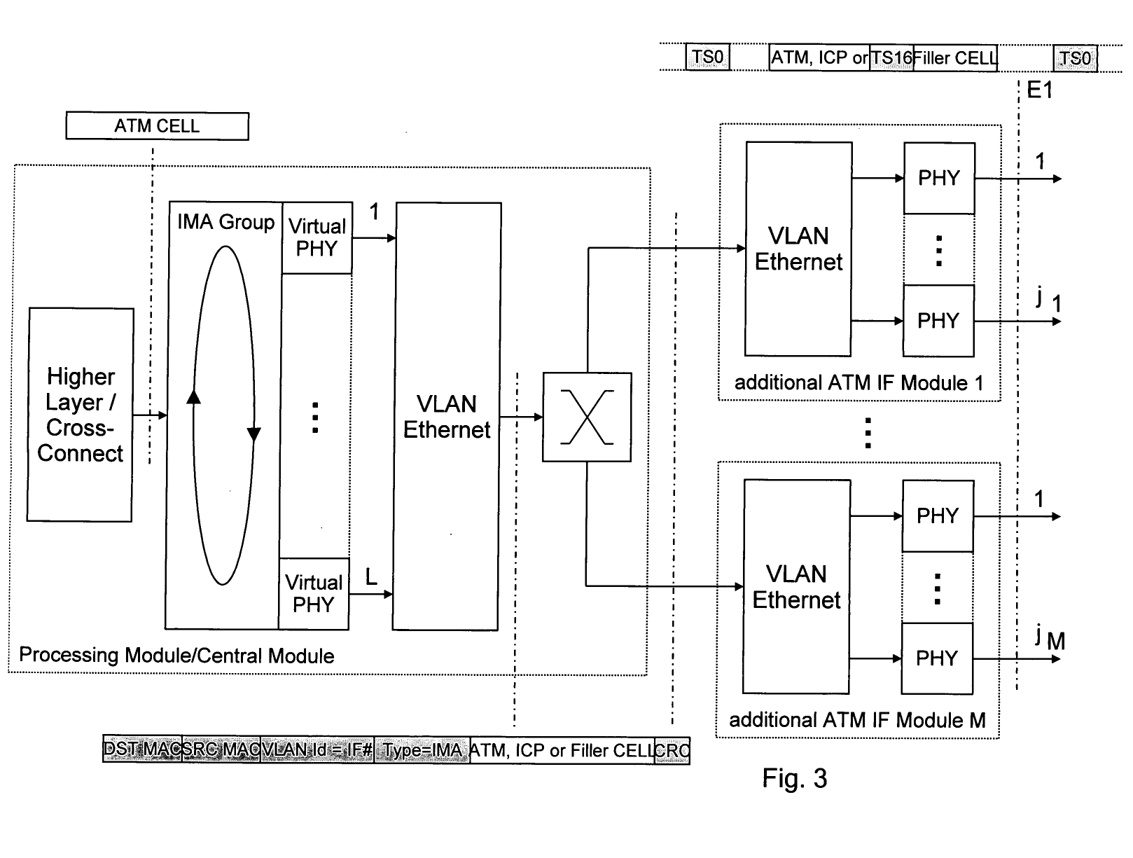

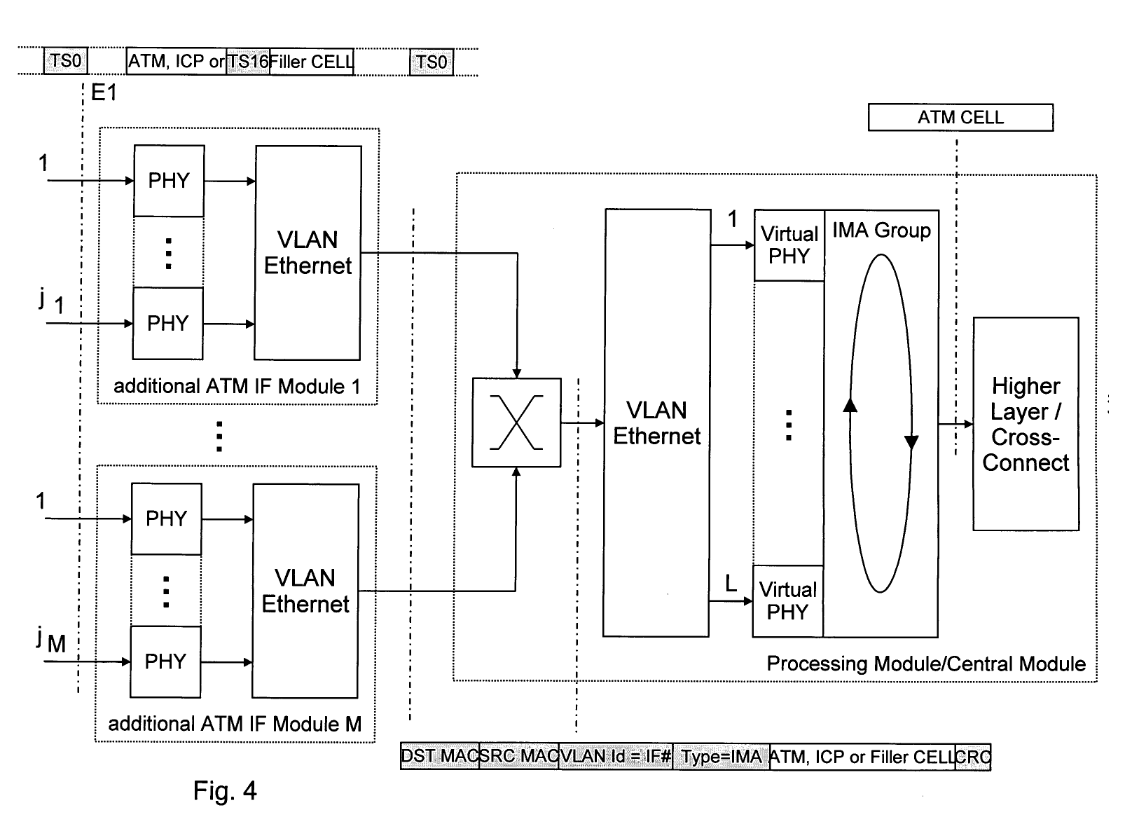

Alternatively, as shown in. FIGS. 3 and 4, the IMA sublayer may be implemented on a processing module having no physical interfaces at all (e.g. on a central module). In this case, there are only virtual interfaces on this processing module. The physical interfaces are implemented on additional physical interface modules, and are connected to the virtual interfaces on the processing module.

The alternative embodiment according to FIGS. 3 and 4 can also be viewed as a special case of the first embodiment according to FIGS. 1 and 2 with K=0, and the first physical interface module becoming a processing module.

In FIGS. 1 and 2, the number M of additional physical interface modules required is related to the number of physical interfaces jᵢ (i=1 . . . M) of the additional physical interface module i and the number of virtual interfaces L of the first physical interface module, with

$$L = {\sum }_{i = 1}^{M} {j}_{i} .$$

In FIGS. 3 and 4, the number M of physical interface modules required is related to the number of physical interfaces jᵢ (i=1 . . . M) of the additional physical interface module i and the number of virtual interfaces N of the processing module, with

$$L = N = {\sum }_{i = 1}^{M} {j}_{i} .$$

The multi-module IMA shown in FIGS. 1 to 4 may comprise encapsulating means (not shown) for encapsulating ATM cells in network architecture frames to be transmitted between the first and the additional physical interface modules (FIGS. 1 and 2), or between the processing module and the additional physical interface modules (FIGS. 3 and 4). The encapsulating means may be implemented in the network architecture. The virtual interfaces may then convert data received in network architecture format into an IMA sublayer format.

Moreover, the multi-module IMA may comprise associating means (not shown) for associating the physical interfaces of the additional physical interface module(s) and the virtual interfaces of the first physical interface module (FIGS. 1 and 2), or for associating the physical interfaces of the additional physical interface modules with the virtual interfaces of the processing module (FIGS. 3 and 4). The associating means may also be implemented in the network architecture.

In the following an implementation example of the multi-module IMA is described. First, an arrangement according to FIGS. 1 and 2 is described.

It is assumed an ATM switch/cross-connect architecture comprising ATM physical interface modules and an Ethernet switch as central switching element located on a central module as shown e.g. in FIG. 1. The ATM physical interface modules contain several physical interfaces (PHYs). The ATM physical interface modules are connected via Ethernet point-to-point links to the Ethernet switch. ATM cells are encapsulated in Ethernet frames when being forwarded between ATM physical interface modules.

The multi-module mechanism is transparent for the IMA sublayer: PHYs and Virtual PHYs have the same interface to the IMA sublayer. Thus, there is no additional implementation effort on the IMA sublayer.

The multi-module IMA works with multiple ATM physical interface modules; according to the standard, IMA supports up to 32 physical interfaces. The additional delay for the Ethernet detour is insignificant at Fast or Gigabit Ethernet speed; IMA can handle 25 msec link differential delay.

In case a link on an ATM physical interface module not implementing or not operating the IMA sublayer fails (or is restored), a link failure (restoring) information is conveyed via a special Ethernet frame to the corresponding virtual PHY. The virtual PHY maps this information to a format defined for the PHY/IMA sublayer interface. The IMA sublayer can then take the appropriate actions.

The PHYs on the ATM physical interface modules not implementing or not operating the IMA sublayer (additional physical interface modules) and the virtual PHYs on the ATM physical interface module implementing and operating the IMA sublayer (first physical interface module) need to be associated. For example, VLAN (Virtual Local Area Network) Ethernet format can be used for this purpose. Each association has then a unique VLAN identifier. In other words, the VLAN Identifier denotes the physical interface on the ATM physical interface modules not implementing or not operating the IMA sublayer.

Some ATM layer functions (e.g. scheduling, shaping, OAM (Operation, Administration, Maintenance)) have to be deactivated on the ATM physical interface modules not implementing or not operating the IMA sublayer. Also some Physical Layer functions have to be deactivated there (no idle cells, no bad cell discarding). The IMA sublayer on the first physical interface module adopts this functionality.

The virtual PHYs are implemented in the first ATM physical interface module implementing and operating the IMA sublayer. Typical PHY functionalities as cell delineation, cell scrambling, HEC generation, HEC verification may be already done by the PHYs on the additional ATM physical interface modules not implementing or not operating the IMA sublayer so that the virtual PHYs form mainly a “glue layer” which converts the information received via Ethernet to the format expected by the IMA sublayer.

It is also feasible to have an IMA sublayer which is connected to virtual PHYs only. With such an arrangement as shown in FIGS. 3 and 4, IMA can be implemented on a processing module having no physical interfaces at all. The physical interfaces are all located on other modules (ATM physical interface modules).

The multi-module IMA is not restricted to an ATM switch/cross-connect with internal Ethernet architecture. Other internal architectures are also feasible, provided that the architecture can transparently forward ATM cells between the modules.

According to the invention, current practical restrictions in the number of physical interfaces for one IMA group can be overcome. The invention enables applying the IMA standard as specified. According to an implementation example, VLAN is applied for differentiating virtual interfaces, and Ethernet can be applied for a transport of ATM cells between modules.

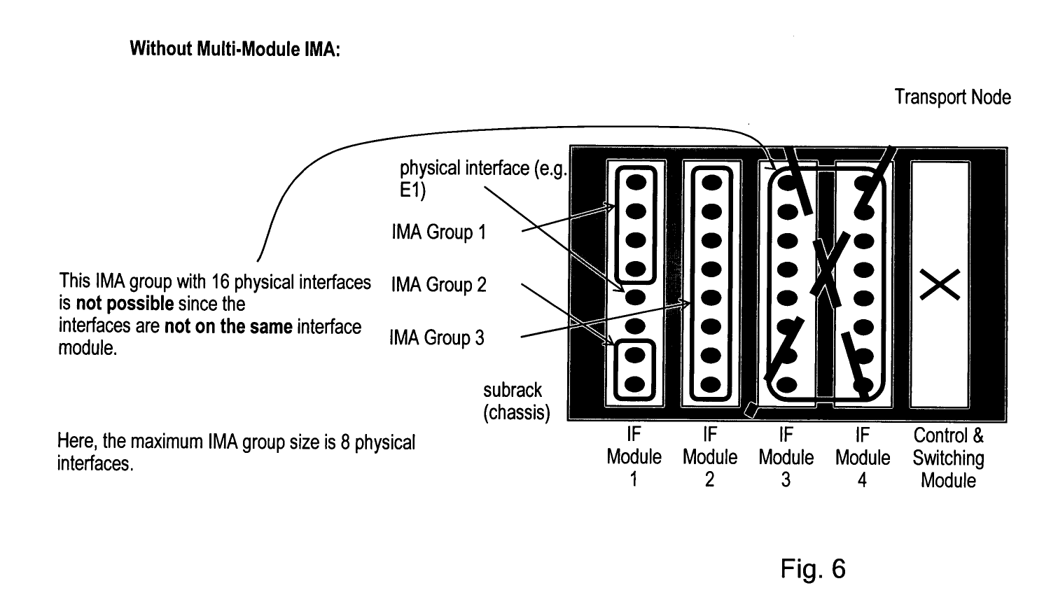

FIG. 6 shows a transport node without multi-module IMA. The transport node comprises four interface (IF) modules and one control and switching module in one subrack. Each IF module comprises eight physical interfaces (e.g. of E1 type). Three IMA groups 1 to 3 are shown, comprising 4, 2 and 8 physical interfaces, respectively. However, an IMA group comprising more than 8 physical interfaces is not possible since all interfaces of an IMA group have to be located on one IF module.

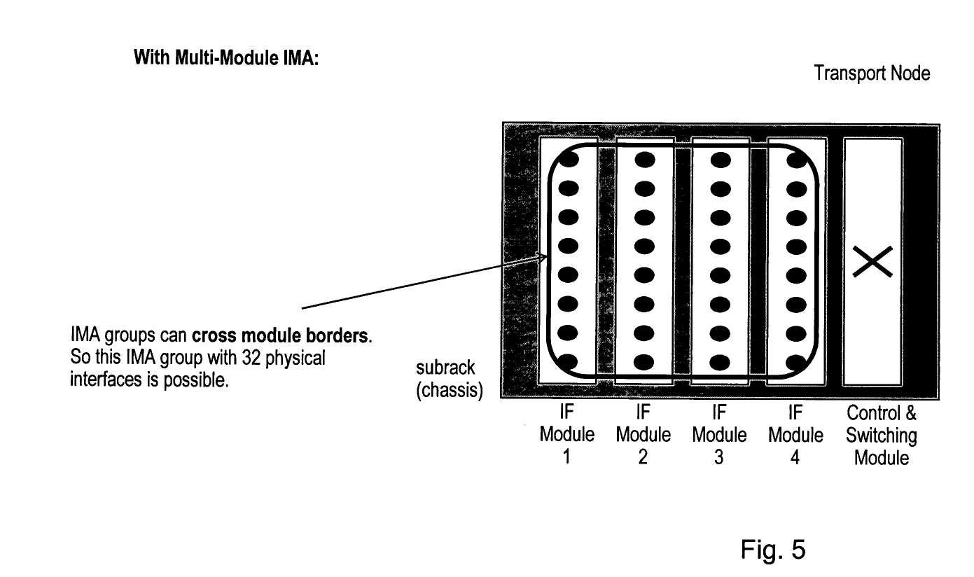

FIG. 5 shows a transport node with multi-module IMA. The transport node comprises four IF modules each having eight physical interfaces. With multi-module IMA, an IMA group with 32 physical interfaces is possible, e.g. by employing an arrangement as shown in FIGS. 3 and 4 with a control and switching module having 32 virtual interfaces, and each IF module 1 to 4 having its 8 physical interfaces connected to virtual interfaces of the control and switching module.

A system for distributing cells of an ATM cell stream across IMA links via interfaces or recombining ATM cells received from IMA links via interfaces into an ATM cell stream is disclosed. With this invention, IMA is no longer restricted to one physical interface module, and the IMA standard can be applied as it is specified, i.e. up to 32 physical interfaces can be used. The system comprises a first module comprising N interfaces, the interfaces comprising L virtual interfaces (L≦N), at least one additional physical interface module comprising physical interfaces, and a network architecture for connecting the physical interfaces of the additional physical interface modules to the virtual interfaces of the first module. Thus, IMA can encompass several physical interface modules, and practical restrictions in the number of physical interfaces can be overcome.

Furthermore, several instances of multi-module IMA can be active in one system at the same time. These instances can be distributed among different modules.

It is to be understood that the above description is illustrative of the invention and is not to be construed as limiting the invention. Various modifications and applications may occur to those skilled in the art without departing from the true spirit and scope of the invention as defined by the appended claims.

1. A system for distributing cells of an ATM cell stream across IMA links via interfaces or recombining ATM cells received from IMA links via interfaces into an ATM cell stream, the system comprising:
a module implementing and operating an IMA sublayer, the module comprising N interfaces, the interfaces comprising L virtual interfaces wherein L≦N; and
at least one physical interface module comprising physical interfaces connecting to the virtual interfaces of the module implementing and operating the IMA sublayer.

2. The system according to claim 1, further comprising:
a network architecture for connecting the virtual interfaces of the module implementing and operating the IMA sublayer to the physical interfaces of the at least one physical interface module.

3. The system according to claim 2, wherein the system is arranged in a transport node and the network architecture comprises a transport node-internal network architecture.

4. The system according to claim 1, wherein the virtual interfaces of the module implementing and operating the IMA sublayer comprise K physical interfaces, wherein K=N−L.

5. The system according to claim 2, further comprising encapsulating means for encapsulating ATM cells in network architecture frames to be transmitted between the module implementing and operating the IMA sublayer and the at least one physical interface module.

6. The system according to claim 1, wherein the module implementing and operating the IMA sublayer houses a working IMA sublayer, and wherein the at least one physical interface module does not house a working IMA sublayer.

7. The system according to claim 2, further comprising: associating means for associating the physical interfaces of the at least one physical interface module and the virtual interfaces of the module implementing and operating the IMA sublayer.

8. The system according to claim 1, further comprising: M physical interface modules comprising jᵢ physical interfaces, wherein i=1 . . . M, with
$$L = {\sum }_{i = 1}^{M} {j}_{i} .$$

9. The system according to claim 1, wherein the module implementing and operating the IMA sublayer comprises N virtual interfaces.

10. The system according to claim 2, wherein the virtual interfaces are configured to convert data of a network architecture format into an IMA sublayer format.

11. A module implementing and operating an IMA group distributing cells of an ATM cell stream across IMA links via interfaces or recombining ATM cells received from IMA links via interfaces into an ATM cell stream, the module comprising:
N interfaces, the interfaces comprising L virtual interfaces connected to physical interfaces of at least one physical interface module, wherein L≦N.

12. The module according to claim 11, further comprising:
a network architecture for connecting the virtual interfaces to the physical interfaces of the at least one physical interface module.

13. A physical interface module of an IMA group distributing cells of an ATM cell stream across IMA links via interfaces or recombining ATM cells received from the IMA links via interfaces into the ATM cell stream, the physical interface module comprising:
physical interfaces connected to virtual interfaces of at least one other module implementing and operating an IMA group.

14. The physical interface module according to claim 13, from comprising:
a network architecture for connecting the physical interfaces to the virtual interfaces of the at least one other module.

15. A network architecture for transferring ATM cells belonging to ATM cell substreams resulting from IMA processing, the network architecture comprising:
transferring means for transferring ATM cells; and connecting means for connecting virtual interfaces of a module implementing and operating an IMA sublayer and physical interfaces of at least one physical interface module.

16. The network architecture according to claim 15, further comprising:
a switching element for transferring ATM cells belonging to ATM cell substreams resulting from IMA processing between the module implementing and operating the IMA sublayer and the at least one physical interface module.

17. A method of distributing cells of an ATM cell stream across IMA links via interfaces or recombining ATM cells received from IMA links via interfaces into an ATM cell stream, the method comprising:
a step of transmitting/receiving ATM cells via L virtual interfaces of a module implementing and operating an IMA sublayer, the module implementing and operating the IMA sublayer comprising N interfaces, wherein L≦N, and wherein at least one of the L virtual interfaces of the module implementing and operating the IMA sublayer is connected with a physical interface of at least one physical interface module.

18. A method of distributing cells of an ATM cell stream across IMA links via interfaces or recombining ATM cells received from IMA links via interfaces into an ATM cell stream, the method comprising:
a step of transmitting/receiving ATM cells via physical interfaces of at least one physical interface module, wherein at least one physical interface of the at least one physical interface module is connected with a virtual interface of a module implementing and operating an IMA sublayer.

19. A method of distributing cells of an ATM cell stream across IMA links via interfaces or recombining ATM cells received from the IMA links, via the interfaces into an ATM cell stream, the method comprising:
a step of connecting physical interfaces of at least one physical interface module to virtual interfaces of another module.

20. A computer program embodied on a computer readable medium, said computer program controlling a computer to execute a process comprising:
a step of transceiving ATM cells via L virtual interfaces of a module implementing and operating an IMA sublayer, the module implementing and operating the IMA sublayer comprising N interfaces, wherein L≦N, and wherein at least one of the L virtual interfaces of the module implementing and operating the IMA sublayer is connected with a physical interface of at least on physical interface module.

21. A computer program embodied on a computer readable medium, said computer program controlling a computer to execute a process comprising:
a step of transceiving ATM cells via physical interfaces of at least one physical interface module, wherein at least one physical interface of the at least one physical interface module is connected with a virtual interface of a module implementing and operating an IMA sublayer.

22. A computer program embodied on a computer readable medium, said computer program controlling a computer to execute a process comprising:
a step of connecting physical interfaces of at least one physical interface module to virtual interfaces of another module.

23. The computer program according to claim 20, wherein the computer program product is directly loadable into an internal memory of the computer.

24. The computer program according to claim 21, wherein the computer program product is directly loadable into an internal memory of the computer.

25. The computer program according to claim 22, wherein the computer program product is directly loadable into an internal memory of the computer.
